(19) United States
(12) Patent Application Publication
(10) Pub. No.: US 2011/0259866 A1
(43) Pub. Date: Oct. 27, 2011

(54) SYSTEM FOR SNOW AND ICE REMOVAL

(76) Inventor: James R. NELSON, Annville, PA (US)

(21) Appl. No.: 13/174,967

(22) Filed: Jul. 1, 2011

Related U.S. Application Data
(63) Continuation-in-part of application No. 12/540,468, filed on Aug. 13, 2009.

(51) Int. Cl. B60L 1/02

(52) U.S. Cl. 219/202

(57) ABSTRACT

A system for removing frozen precipitation that has accumulated on a surface of a road vehicle is disclosed. In an embodiment, the system includes a hydrophobic and/or low friction sheet attached to an upper surface of the road vehicle. The system may further include a heating array attached to the surface and a power source.

This application is a continuation in part of application U.S. patent application Ser. No. 12/540,468, filed Aug. 13, 2009, for which priority is claimed and which disclosure is incorporated by reference in its entirety.

### FIELD OF THE INVENTION

The present invention is generally directed to the removal of ice and snow, and more particularly to a system for removing ice and snow from the surface of a truck trailer.

### BACKGROUND OF THE INVENTION

The accumulation of snow and/or ice, hereinafter referred to as “frozen precipitation” on the surface or roof of road vehicles such as vans, trucks, semi-trailer trucks and other large vehicles presents a substantial problem. Frozen precipitation may accumulate on the roof of the vehicle while the vehicle is stopped, parked or otherwise stationary, and may also accumulate on the vehicle roof while the vehicle is moving.

If the frozen precipitation is not removed from the roof of the vehicle, slabs or other solid mass forms of the frozen precipitation may become separated from the vehicle roof and fly off or otherwise fall from the moving vehicle. The flying mass may strike or impact one or more vehicles following behind the moving vehicle, may cause another vehicle to swerve to avoid the flying mass, and/or may form an obstruction on the road surface. In such a manner, the flying and/or obstruction mass may cause damage or lead to an accident. For example, the flying mass may impact and break a windshield of a following car and result in one or more accidents. For at least these reasons, some jurisdictions require that ice and/or snow be removed from a vehicle before the vehicle may travel on roadways.

In some attempts to remove frozen precipitation from the roof of a vehicle, an operator may climb on the roof and remove the frozen precipitation by shoveling, scraping or other similar manual method. For example, see U.S. Patent Pub. No. 2008/0086919, which discloses a scraping device for removing snow from a vehicle. However, such methods represent a substantial safety and cost issue for the operator.

In other attempts, frozen precipitation may be removed from a vehicle roof surface by a static structure that includes a horizontal member that removes the frozen precipitation by scraping the vehicle roof as that the vehicle passes beneath the structure. In yet other attempts, an operator may move the vehicle to or into a facility where the frozen precipitation is removed by heating and/or spraying with de-icing and/or melting agents. However, these attempts are only practical wherein a large number of vehicles are present so as to justify the expense thereof. They do not provide a solution for a single or few vehicles that can be in a location wherein such a structure is not available.

Thus, a long felt need exits to economically remove frozen precipitation from a surface of a road vehicle.

What is needed is a system and method to remove frozen precipitation from the roof of a road vehicle, and in particular to remove frozen precipitation from a large vehicle such as a tractor-trailer.

### SUMMARY OF THE INVENTION

A first aspect of the disclosure includes a snow and ice removal system for removing frozen precipitation from a surface of a vehicle, including a polymer sheet substantially overlaying an upper surface of a tractor trailer.

A second aspect of the disclosure includes a tractor trailer including an upper surface and a frozen precipitation removal system affixed to the surface. The frozen precipitation removal system includes a polymer sheet attached to the upper surface of the tractor trailer.

A third aspect of the disclosure includes a snow and ice removal system for removing frozen precipitation from a surface of a vehicle including a polymer layer substantially overlaying an upper surface of a tractor trailer.

A fourth aspect of this disclosure includes a tractor trailer including an upper surface, wherein the upper surface defines a curved geometry and wherein at least the side edges of the upper surface are positioned below the rest of the upper surface.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a perspective view of a tractor trailer having an exemplary embodiment of a snow and ice removal system according to the invention installed thereupon.

FIG. 2 illustrates a perspective view of a tractor trailer having another exemplary embodiment of a snow and ice removal system according to the invention installed thereupon.

FIG. 3 illustrates a perspective view of a tractor trailer having another exemplary embodiment of a snow and ice removal system according to the invention installed thereupon.

FIG. 4 illustrates a perspective view of a tractor trailer having another exemplary embodiment of a snow and ice removal system according to the invention installed thereupon.

### DETAILED DESCRIPTION OF THE INVENTION

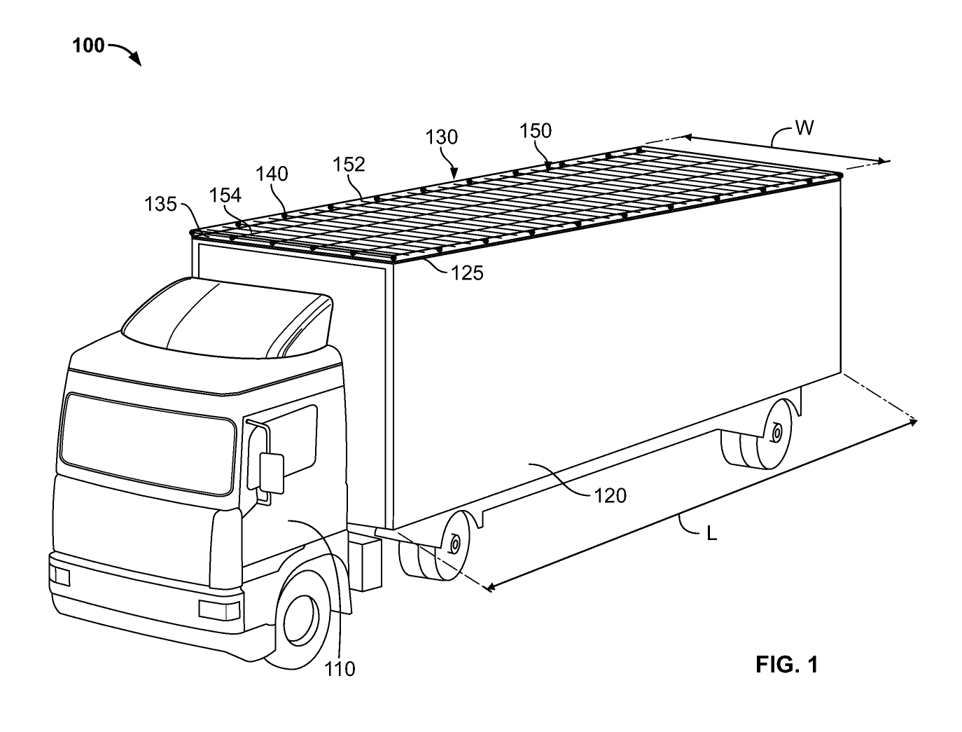

FIG. 1 illustrates a road vehicle 100 including a towing engine or trailer 110 and a semi-trailer 120 having an exemplary embodiment of a snow and ice removal system (system) 130 according to the disclosure attached thereto. Within this disclosure, the term “snow and ice” includes any form of frozen precipitation, including, but not limited to snow, ice, sleet, freezing rain and hail. Furthermore, in this exemplary embodiment, the road vehicle is a tractor trailer. However, in other embodiments, the road vehicle 100 may be any vehicle, motorized or non-motorized, that travel on a road, such as, but not limited to trucks, trailers, semi-trailers, towed oversized structures including housing structures and mobile homes.

As further shown in FIG. 1, the system 130 includes a layer or sheet 135 of a material that incorporates a heating array 150 and a power source (not shown). The heating array 150 is contained within or disposed within the sheet 135. In another embodiment, the heating array 150 may be attached on the upper surface and/or underneath surface and/or embedded within the sheet 135. In one embodiment, layer or sheet 135 can be a coating applied beneath or over the heating array. In another embodiment, the heating array is not contained within or disposed within a sheet and is installed over a conventional semi-trailer or other vehicle.

The sheet 135 may be formed of a metal, polymer or composite material having a low coefficient of friction against a solid and/or be hydrophobic. In an embodiment, the sheet 135 may be formed of fluoropolymer, such as polytetrafluoroethylene (PTFE). PTFE is most well known by the DuPont brand name Teflon™. PTFE is a fluorocarbon solid, a high-molecular-weight compound consisting wholly of carbon and fluorine. PTFE is hydrophobic: neither water nor water-containing substances wet PTFE, as fluorocarbons demonstrate mitigated London dispersion forces due to the high electronegativity of fluorine. PTFE has one of the lowest coefficients of friction against any solid.

As can be seen in FIG. 1, the sheet 135 and/or heating array 150 is attached to a surface 125 of the semi-trailer 120. In this exemplary embodiment, the surface 125 is the horizontal planar roof of the semi-trailer 120. In another embodiment, the surface 125 may be an upper surface of the semi-trailer 120. In another embodiment, the surface 125 may be non-planar. For example, the surface 125 may be stepped or otherwise discontinuous, or may be curved. In another embodiment, the surface 125 may include ridges or other non-planar elements.

The sheet and/or heating array 150 is attached to the surface 125 by fasteners 140. The fasteners 140 may be, but are not limited to, clips, loops, anchor hooks, hasps or other retainers. The fasteners 140 may detachably attach or permanently affix the system 130 to the surface 125. In one embodiment, the fasteners 140 are detachable from the surface 125. For example, the fasteners 140 may be detachably received in slots in the surface 125 or bolted to the surface 125. In another embodiment, the fasteners 140 are permanently affixed to the surface 125. For example, the fasteners 140 may be molded into or welded to the surface 125. In one embodiment, the fasteners 140 allow the heating array 150 to be detached from the surface 125. The fasteners 140 retain the sheet 135 and/or heating array 150 in substantial contact with the surface 125.

In this exemplary embodiment, the surface 125 is substantially planar or flat, however, in other embodiments, the surface 125 may be ridged or otherwise non-planar. In another embodiment, the heating array 150 contacts the surface 125 at contact points. In yet another embodiment, the surface 125 may include channels, slots, grooves, toughs or other receiving features (not shown) for at least partially supporting and/or containing the sheet 135 and/or heating array 150.

The heating array 150 includes a plurality of resistive heating elements 152 electrically connected in parallel across the width W of the semi-trailer 120. The resistive heating elements 152 may be electric cable having a hot insulated conductor and a neutral insulated conductor (not shown). The hot and neutral insulated conductors may be wrapped with a braided ground to protect against shock in the unlikely event that any of the plurality of resistive heating elements 152 are punctured.

The heating array 150 may include an array of support lines 154 provided across the length L of the semi-trailer 120. The support lines 154 space the resistive heating elements 152 at a predetermined fixed spacing across the semi-trailer 120. In one embodiment, the support lines 154 may be an elastic web or film. For example, the support lines 154 may be formed of a heat-resistant polymer web material. The support lines 154 may be formed of a Teflon™ web or film.

In this exemplary embodiment, the sheet 135 and heating array 150 are provided across the length L of the semi-trailer 120 and width W of the semi-trailer. In another embodiment, the sheet 135 and/or heating array 150 are provided across a portion of the length L and/or width W of the semi-trailer. The sheet 135 and/or heating array 150 may include locking devices (not shown) to securely affix the sheet 135 and/or heating array to the semi-trailer 120.

The sheet 135 and/or heating array 150 may be assembled to the surface 125 at the time of assembly of the semi-trailer 120. In yet another embodiment, the sheet 135 and/or heating array 150 is retro-fitted or otherwise later added to the semi-trailer 120 after the manufacture of the semi-trailer 120.

In one embodiment, the heating array 150 is electrically connected to a power source (not shown) via an electrical wire or cable (not shown). The electrical cable may be permanently attached or detachable from the heating array 150. In another embodiment, the electrical cable is attached to the power source and connected to the heating array 150. In one embodiment, the electrical cable is a No. 1 or No. 00 gauge copper wire cable. In one embodiment, an electrical power safety device (not shown) may be electrically disposed between the heating array 150 and the power source. For example, the electrical power safety device may be a fuse, breaker or other ground break device.

In one embodiment, the power source is a portable generator that is temporarily electrically connected to the heating array 150. The power source may or may not include the electrical cable used to attach the power source to the heating array. In one embodiment, the portable generator may be a 15 kw, 20 kw, 26 kw or 30 kw generator. In one embodiment, the power source provides between about 240 volt to about 480 volts. The portable generator may be gasoline or diesel fuel powered.

In another embodiment, the power source may be a solar power collector, such as a photovoltaic cell, that energizes the heating array 150. In another embodiment, the power source may be a battery. The battery may be carried by the road vehicle 100 or may be provided at a stationary location.

In one embodiment, the power source provides electrical energy to the heating array 150 to produce between about 1 to about 5 watt per square inch. In another embodiment the power source provides between about 2 to about 3 watt per square inch to the heating array 150. In another embodiment, the system 130 further includes a temperature control unit (not shown) to control the heat generated by the heating array 150. In one exemplary embodiment, the temperature control unit includes a resistance temperature sensor configured to regulate the heat of the heating array 150 to between about 150° F. to about 200° F. In another embodiment, the heating array 150 includes a inline temperature sensor probe to control the amount of heat generated by the heating array 150.

In another embodiment, the power source is an electrical supply point, such as an electrical outlet or an electrical source, such as a power panel, to which the electrical cable is attached. The power source provides electricity to the heating array 150 to substantially melt and thus remove any frozen precipitation that has accumulated on the surface 125 before the vehicle or tractor trailer 100 begins to travel.

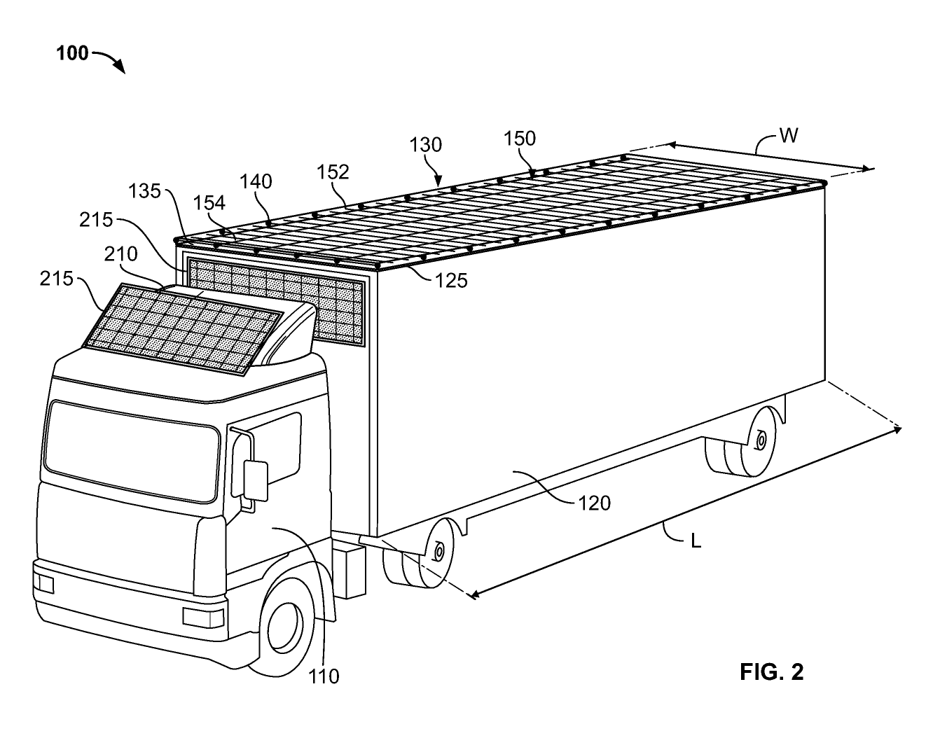

FIG. 2 illustrates an embodiment of the system 130 including a solar power source 210 mounted on the vehicle 100. The solar power source 210 includes two solar panels 215 attached to the vehicle 100. In another embodiment, the solar power source 210 may include one or more solar panels 215. The solar power source 210 is attached to an electrical power system (not shown) that provides electrical energy to the heating array 150. The solar power source 210 may include wires, leads, batteries and other electrical components.

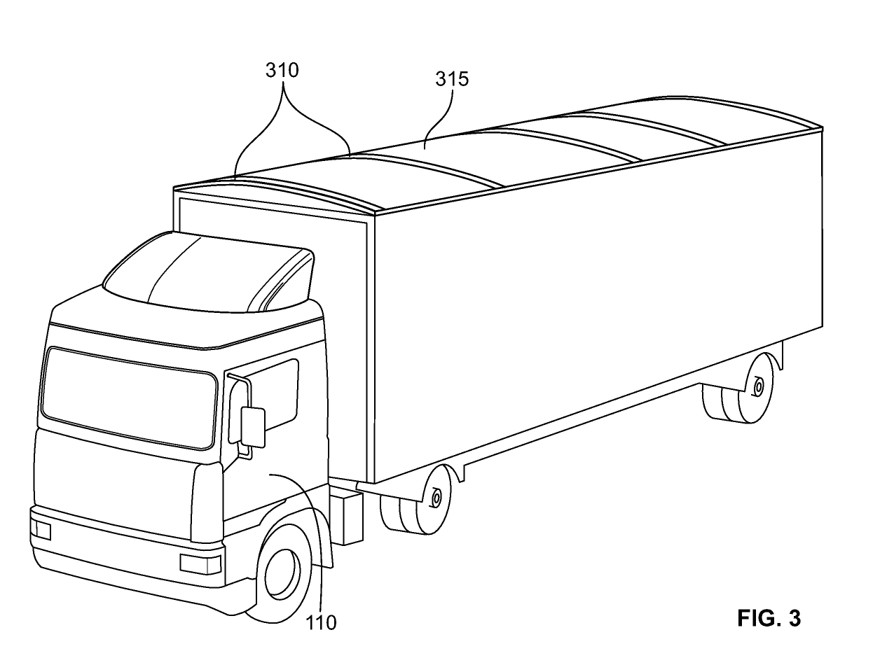

FIG. 3 illustrates another embodiment of the system 130, including an upper or top surface 315 of the tractor-trailer supported by bow supports 310. Optionally, the sheet 135 and heating array 150 (FIG. 1) can be included and would also be supported by bow supports 310. In an embodiment, the sheet 135 and heating array 150 may be supported by one or more bow supports 310. The bow supports 310 support the sheet 135 and heating array 150 in a curved, bowed, or otherwise domed geometry, which assists in shedding, sliding, or removing snow or ice from the sheet 135. In another embodiment, the surface 315 may be bowed or curved to support the sheet 135 and heating array 150 in a bowed configuration or profile. In another embodiment, the bowed sheet 135 does not include heating array 150. As shown, the upper or top surface 315 is bowed or curved such that the side edges of the top surface are positioned below the rest of the top surface. In a further embodiment, sheet 135 is bowed such that all peripheral edges of the sheet overlaying the top of the tractor-trailer are lower than the rest of the surface of the tractor-trailer. In a further embodiment, the curved, or bowed or domed upper or top surface 315 of the tractor-trailer does not include the sheet and heating array as shown in FIG. 1. In a further embodiment, the curved, or bowed or upper or top surface 315 of the tractor-trailer includes a coating layer, such as a sprayed on layer of material having a low coefficient of friction, such as PFTE.

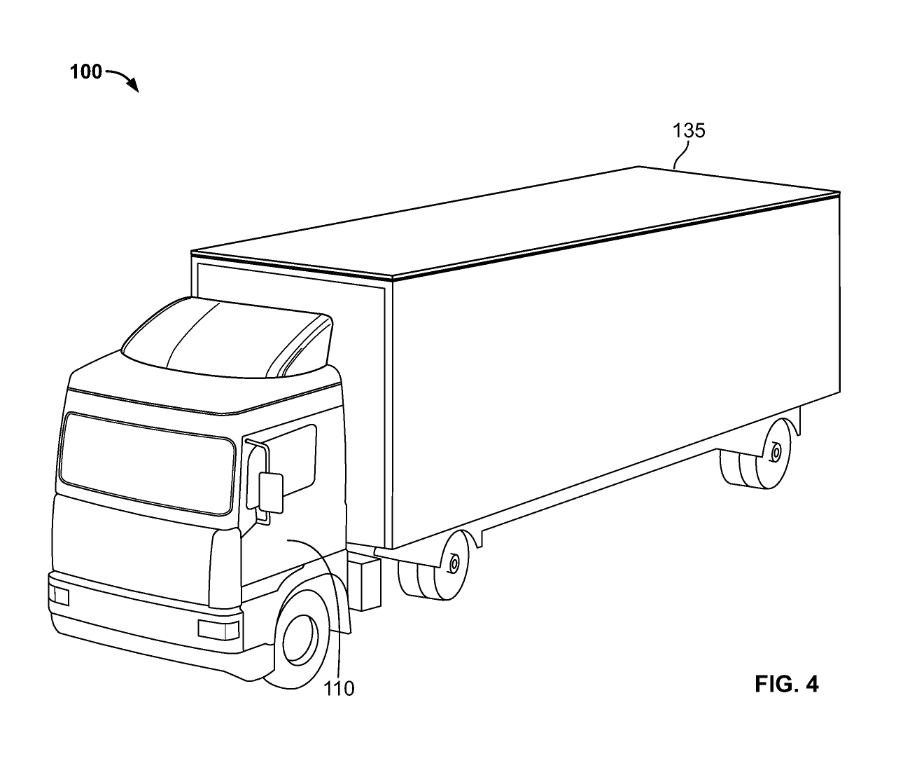

FIG. 4 illustrates another embodiment of the system 130. In this exemplary embodiment, the system 130 includes the sheet 135, and no heating array 150. The sheet 135 is attached to the surface 125, which has a substantially flat profile. In another embodiment, the sheet 135 may be flat or have a bowed profile as discussed in regard to FIG. 3 above. In another embodiment of system 130, a layer 235 of material is applied to the upper surface of the tractor trailer 100. In another embodiment of system 130, layer 235 of material comprises a coating. In a further embodiment of the system 130, layer 235 is formed by a spraying technique including, but not limited to, an air pressure spray system, a mechanical brush system or manual brush technique. In yet another embodiment of the system 130, the upper surface of the tractor trailer is curved, as previously discussed.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A snow and ice removal system for removing frozen precipitation from a surface of a vehicle, comprising:
a polymer sheet substantially overlaying an upper surface of a tractor trailer.

2. The system of claim 1, further comprising:
a plurality of fasteners configured to attach the polymer sheet to the upper surface.

3. The system of claim 1, wherein the sheet is formed of polytetrafluoroethylene.

4. The system of claim 1, further comprising a heating array in contact with the polymer sheet.

5. The system of claim 4, further comprising a power source configured to provide electrical power to the heating array and generate heat.

6. The system of claim 4, wherein the heating array comprises a resistive heating element.

7. The system of claim 5, wherein the power source comprises a solar panel.

8. The system of claim 1, wherein the sheet defines a curved geometry.

9. The system of claim 8, wherein all edges of the overlaid tractor-trailer surface are positioned below the rest of the tractor-trailer surface.

10. The system of claim 1, wherein the sheet defines a domed geometry.

11. A tractor trailer comprising,
an upper surface; and
a frozen precipitation removal system affixed to the surface, the frozen precipitation removal system comprising a polymer sheet attached to the upper surface of the tractor trailer.

12. The tractor trailer of claim 11, wherein the sheet is formed of polytetrafluoroethylene.

13. The tractor trailer of claim 11, further comprising a heating array in contact with the polymer sheet.

14. The tractor trailer of claim 13, further comprising a power source configured to provide electrical power to the heating array and generate heat.

15. The tractor trailer of claim 13, wherein the heating array comprises a resistive heating element.

16. The tractor trailer of claim 14, wherein the power source comprises a solar panel.

17. A snow and ice removal system for removing frozen precipitation from a surface of a vehicle, comprising
a polymer layer substantially overlaying an upper surface of a tractor trailer.

18. The system of claim 17, wherein the layer is a coating.

19. The system of claim 18, wherein the coating is applied by spraying.

20. The system of claim 17, wherein the upper surface of the tractor-trailer defines a curved geometry.

21. A tractor trailer comprising
an upper surface,
wherein the upper surface defines a curved geometry wherein at least side edges of the upper surface are positioned below the rest of the upper surface.
